(19) United States
(12) Patent Application Publication
(10) Pub. No.: US 2017/0017699 A1
(43) Pub. Date: Jan. 19, 2017

(54) METHOD AND SYSTEM FOR GENERATING MAP DATA

(71) Applicant: MasterCard Asia/Pacific Pte. Ltd., Singapore (SG)

(72) Inventors: Vijin Venugopalan, Singapore (SG); Prashant Sharma, Madison, NJ (US); Joseph Hayes, Montclair, NJ (US)

(21) Appl. No.: 15/210,441

(22) Filed: Jul. 14, 2016

(30) Foreign Application Priority Data
Jul. 16, 2015 (SG) 10201505580V

(51) Int. Cl. G06F 17/30; G06Q 50/10

(52) U.S. Cl. CPC G06F 17/30551; G06F 17/30241; G06F 17/30353; G06F 17/30061; G06Q 50/10

(57) ABSTRACT

A method of generating map data, a system for generating map data and a method of creating a merchant map based on the generated map data are disclosed. The method of generating map data includes receiving transaction data from a merchant over a communications network, the transaction data including merchant identification data and a time-stamp of the transaction, determining a physical address of the merchant from the merchant identification data, mapping the physical address of the merchant to corresponding geographical coordinates using a geolocation database. The method further includes associating the geographical coordinates with the merchant's identity from the merchant identification data and storing the geographical coordinates, merchant's identity and time-stamp as elements of map data.

### CROSS-REFERENCE TO RELATED APPLICATION

This application is a U.S. National Stage filing under 35 U.S.C. §119, based on and claiming benefit of and priority to SG Patent Application No. 10201505580V filed Jul. 16, 2015.

### FIELD OF INVENTION

The present invention relates broadly, but not exclusively, to methods and systems for generating map data, and methods for creating a merchant map based on the generated map data.

### BACKGROUND

As cities and other urban centers evolve, some businesses, for example, shops, restaurants, service providers, etc., may cease operations and new businesses may be created. At the same time, other businesses may move their premises to new locations for various reasons. These changes take place continually rather than periodically.

In contrast, due to practical constraints, city maps are typically updated on a periodic basis, such as yearly or every six months. Thus, it is possible that such city maps, whether in electronic or printed format, may include outdated information. This can lead to inconvenience and/or inefficiency.

Further, current map providers typically require data from third parties to label or update their maps with the merchant names. Such data may not be always reliable. It is also cumbersome to compare the distribution of merchants at various points in time.

A need therefore exists to provide a method and system for generating map data of merchants (i.e. businesses) that seek to address at least some of the above problems.

### SUMMARY

According to a first aspect of the present invention, there is provided a method of generating map data, the method comprising the steps of:
receiving transaction data from a merchant over a communications network, the transaction data including merchant identification data and a time-stamp of the transaction;
determining a physical address of the merchant from the merchant identification data;
mapping the physical address of the merchant to corresponding geographical coordinates using a geolocation database;
associating the geographical coordinates with the merchant's identity from the merchant identification data; and
storing, in a merchant map database, the geographical coordinates, merchant's identity and time-stamp as elements of map data.

The step of determining a physical address of the merchant from the merchant identification data may comprise extracting the physical address from a respective field in the merchant identification data.

The step of determining a physical address of the merchant from the merchant identification data may comprise identifying a merchant ID from the merchant identification data and querying a merchant address database containing a plurality of merchant IDs and associated addresses using the merchant ID.

The step of storing the geographical coordinates, merchant's identity and time-stamp as elements of map data may comprise storing a elements of map data if the geographical coordinates are changed.

The step of mapping the physical address of the merchant to corresponding geographical coordinates may comprise referencing a first map database containing a plurality of physical addresses and corresponding geographical coordinates using a merchant mapping engine.

The step of storing the geographical coordinates, merchant's identity and time-stamp as elements of map data may comprise making the map data accessible by an application programming interface (API).

According to a second aspect of the present invention there is provided a method of creating a merchant map, the method comprising:
providing a first map layer of an area;
retrieving map data of one or more merchants within said area, wherein the map data is generated using the method as defined in the first aspect;
creating a second map layer containing merchant information for said area based on the retrieved map data; and
superimposing the second map layer onto the first map layer.

The step of providing a first map layer of an area may comprise obtaining the first map layer corresponding to a specified point in time from a map database, the first map layer including at least street layout of the area.

The step of retrieving map data of one or more merchants may comprise retrieving respective elements of map data having a time-stamp prior and closest to the specified point in time.

The step of creating a second map layer may comprise creating a plurality of sub-layers, each sub-layer corresponding to a predetermined point in time.

The step of superimposing the second map layer onto the first map layer may comprise superimposing the plurality of sub-layers in a time-lapsed sequence.

The merchant information may comprise merchant names and/or merchant logos.

According to a third aspect of the present invention, there is provided a system for generating map data, the system comprising:
a merchant data interface connected to a communications network;
a memory unit communicatively coupled with the merchant data interface and configured to receive transaction data from a merchant over the communications network, the transaction data including merchant identification data and a time-stamp of the transaction;
a processor communicatively coupled with the memory unit and configured to determine a physical address of the merchant from the merchant identification data, map the physical address of the merchant corresponding geographical coordinates using a geolocation database, and associate the geographical coordinates with the merchant's identity from the merchant identification data; and
a data storage unit communicatively coupled with the processor and configured to store the geographical coordinates, merchant's identity and time-stamp as elements of map data.

The processor may be configured to extract the physical address from a respective field in the merchant identification data.

The processor may be configured to identify a merchant ID from the merchant identification data and query a merchant address database containing a plurality of merchant IDs and associated addresses using the merchant ID to determine the physical address.

The data storage unit may be configured to store a new set of map data if the geographical coordinates are changed.

The processor may be configured to reference a first map database containing a plurality of physical addresses and corresponding geographical coordinates.

The data storage unit may be configured to make the map data accessible by an application programming interface (API).

According to a fourth aspect of the present invention, there is provided a system for creating a merchant map, the system comprising a processor configured to:
generate a first map layer of an area;
retrieve map data of one or more merchants within said area, wherein the map data stored in the system as claimed in any one of claims 13 to 18;
create a second map layer containing merchant identity for said area based on the retrieved map data; and
superimpose the second map layer onto the first map layer.

The processor may be configured to generate a first map layer by obtaining the first map layer corresponding to a specified point in time from a second map database, the first map layer including at least street layout of the area.

The processor may be further configured to retrieve respective elements of map data having a time-stamp prior and closest to the specified point in time.

The processor may be configured to create the second map layer by creating a plurality of sub-layers, each sub-layer corresponding to a predetermined point in time.

The processor may be further configured to superimpose the second map layer onto the first map layer by superimposing the plurality of sub-layers in a time-lapsed sequence.

The merchant identity may comprise merchant names and/or merchant logos.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram illustrating the creation of a merchant map according to an example embodiment.

FIG. 2 shows a flow chart illustrating a method of generating map data according to an example embodiment.

FIG. 3 shows a schematic diagram illustrating the organization of a set of map data generated using the method of FIG. 2.

FIG. 4 shows a flow chart illustrating a method of creating a merchant map according to an example embodiment

FIGS. 5a-5c show example merchant maps created using the method of the example embodiments.

FIG. 6 shows a schematic diagram illustrating a computer suitable for implementing the method and system of the example embodiments.

### DETAILED DESCRIPTION

Embodiments of the present invention provide a method and system for determining exact locations (in terms of geographical coordinates) of merchants based on transaction data generated by electronic transactions made at or with the merchants. Such map data can be stored and subsequently accessed in the creation of a merchant map within an area, either current or as of any historical point in time, or in the updating of an existing merchant map. The existence of transaction data (or the lack thereof) may also indicate whether a merchant (i.e. business) is active/operational or not. Since electronic transactions take place frequently, the method and system of the example embodiment can provide relatively accurate map data of merchants.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “calculating”, “determining”, “associating”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various programmable machines may be used with programs in accordance with the teachings herein. Alternatively, the construction of more specialized apparatus to perform the required method steps may be appropriate. The structure of a suitable computer is described below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM, GPRS, 3G or 4G mobile telephone systems, as well as other wireless systems such as Bluetooth, ZigBee, Wi-Fi. The computer program when loaded and executed on such a computer effectively results in a special purpose apparatus that implements the steps of the preferred method.

The present invention may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC) or Field Programmable Gate Array (FPGA).

Numerous other possibilities exist. Those skilled in the art will appreciate that the system can also be implemented as a combination of hardware and software modules.

As used herein, the terms “transaction card”, “financial transaction card”, and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of payment card can be used as a method of payment for performing a transaction. In addition, payment card account behavior can include but is not limited to purchases, management activities (e.g. balance checking), bill payments, achievement of targets (e.g. meeting account balance goals, paying bills on time), and/or product registrations (e.g. mobile application downloads).

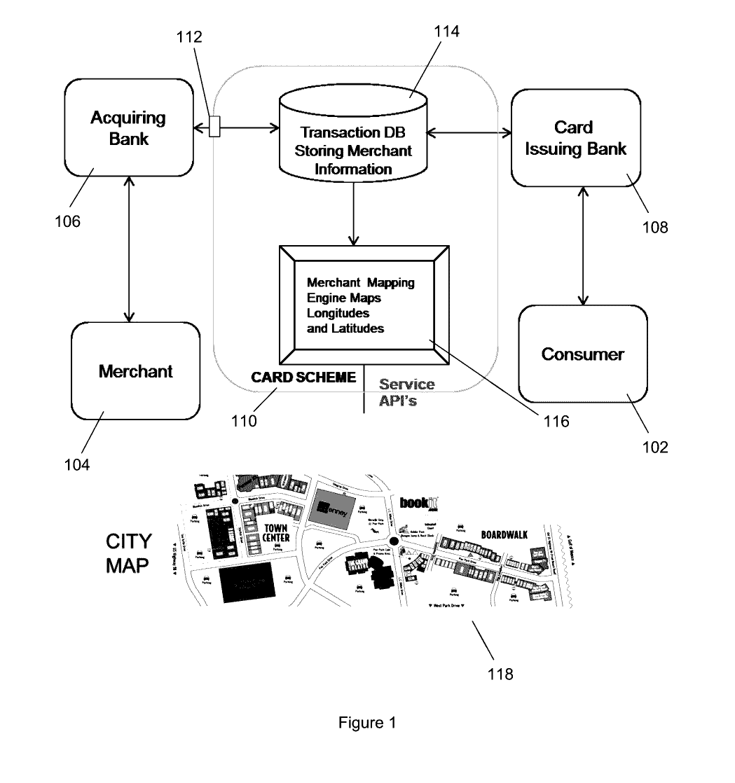

FIG. 1 shows a schematic diagram illustrating the creation of a merchant map according to an example embodiment. Typically, in a payment card transaction, when a payment-card holder (consumer) 102 wishes to purchase a product/service from a merchant 104, the payment-card holder 102 presents his/her payment-card to the merchant 104. The merchant 104 then submits a request to an acquirer 106 (a financial institution such as a bank that processes and settles the merchant's transactions with the help of an issuer). The acquirer 106 then sends the request to the issuer 108 (a financial institution, bank, credit union or company that issues or helps issue cards to payment-card holders) to authorize the transaction. A payment facilitator, also known as a card network or card scheme 110, (e.g. MasterCard®) acts as an intermediary between the acquirer 106 and the issuer 108. The payment facilitator 110 includes a merchant data interface 112 that can receive the transaction data from the merchant 104, indirectly via the acquirer 106. The payment facilitator also has another data interface (not shown) for interacting with the issuer 108. If the acquirer 106 authorizes the transaction, the merchant 104 releases the product/service to the payment-card holder 102.

The transaction authorization process described above involves multiple parties (payment-card holder (consumer) 102, merchant 104, acquirer 106, issuer 108, payment facilitator 110). However, the transaction authorization process may be essentially viewed as a transaction between a payment-card holder 102 and a merchant 104 (with the other parties facilitating the transaction).

During the transaction, certain data associated with the transaction (i.e. transaction data) may be generated and the transaction data may be captured/collected by the payment facilitator 110. Such transaction data may be stored in a transaction database 114. For example, the transaction data may be uploaded to a data warehouse on a regular basis (e.g. daily, weekly, monthly). If necessary, various algorithms/rules can be applied to anonymize the transaction data so that no personally identifiable numbers are available to the users of the transaction data.

The transaction data that can be generated/captured include transaction level information (e.g. Transaction ID, Account ID (anonymized), Merchant ID, Transaction Amount, Transaction Local Currency Amount, Date of Transaction, Time of Transaction, Type of Transaction, Date of Processing, Cardholder Present Code Merchant Category Code (MCC)), Account Information (e.g. Account ID (anonymized), Card Group Code, Card Product Code, Card Product Description, Card Issuer Country, Card Issuer ID, Card Issuer Name, Aggregate Card Issuer ID, Aggregate Card Issuer Name), Merchant Information (e.g. Merchant ID, Merchant Name, MCC/Industry Code, Industry Description, Merchant Country, Merchant Address, Merchant Postal Code, Aggregate Merchant ID, Aggregate Merchant Name, Merchant Acquirer Country, Merchant Acquirer ID), and Issuer Information (e.g. Issuer ID, Issuer Name, Aggregate Issuer ID, Issuer Country).

In the example embodiments as described in more detail below, the transaction data is used to determine the exact location (in terms of geographical coordinates) of the merchant 104, for example, using a merchant mapping engine 116. This information can be stored and accessed by an application programming interface (API) to create a merchant map 118 as of a given point in time, e.g. a particular month of a given year.

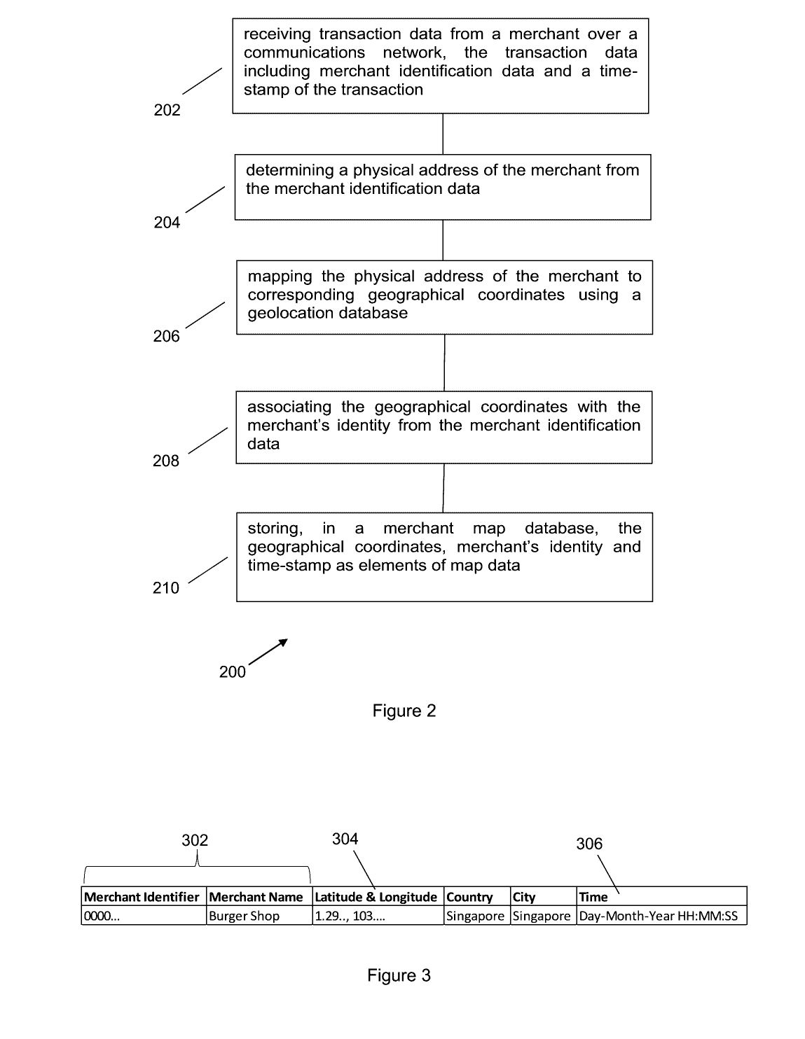

FIG. 2 shows a flow chart 200 illustrating a method of generating map data according to an example embodiment. At step 202, transaction data from a merchant is received from a communications network, the transaction data including merchant identification data and a time-stamp of the transaction. At step 204, a physical address of the merchant is determined from the merchant identification data. At step 206, the physical address of the merchant are mapped to corresponding geographical coordinates using a geolocation database. At step 208, the geographical coordinates are associated with the merchant's identity from the merchant identification data. At step 210, the geographical coordinates, merchant's identity and time-stamp are stored in a merchant map database as elements of map data, which may be specific to the merchant.

As described above, each merchant is uniquely associated with merchant identification data including a physical address (e.g. street address or postal code) and/or merchant ID. Thus, different outlets of the same franchise are considered separate merchants for example. Also, while it is possible to have multiple merchants with the same physical address, such as stores within the same building, a merchant typically normally has only one physical address at a given time. It is expected that the merchant identification data sent by the merchant to the payment facilitator is complete and up to date, thus it is generally possible to determine the physical address of a particular merchant from the merchant identification data.

For example, if the physical address is stored in the transaction data (e.g. as part of the merchant identification data), the physical address can be directly extracted by looking for the relevant field in the merchant identification data. Alternatively, if the merchant ID is stored, the merchant ID can be used to query a separate merchant address database, which contains merchant IDs and associated addresses, to determine the physical address of the merchant.

With reference to step 206, in an implementation, a merchant mapping engine is used to map the physical address of the merchant to the corresponding geographical coordinates, which are typically expressed in longitudes and latitudes. The longitudes and latitudes may be in any suitable format, such as degrees, minutes, and seconds (DMS), degrees and decimal minutes (DMM), or decimal degrees (DD). For example, the merchant mapping engine may use a geolocation database of a map service provider, such as Google Maps, in order to determine the geographical coordinates. With reference to step 208, the merchant's identity includes, for example, the merchant name and/or merchant identifier (e.g. code, logo, etc.) to uniquely identify the merchant.

FIG. 3 shows a schematic diagram illustrating an example organization of elements of map data generated using the method of FIG. 2. As can be seen from FIG. 3, the elements of map data corresponding to a merchant may be organized in a row containing, among other things, the merchant's identity 302 (merchant identifier, merchant name), geographical coordinates 304 (latitude and longitude), the time-stamp 306 (e.g. in date and time format) of the transaction. Optionally, city name and country name may also be provided. The map data can be stored in a merchant map database in a suitable format accessible by a map service API. For example, the map data may be stored in a merchant map database separate from the database maintained by the payment facilitator to store the transaction data. It is also possible to merge the map data to the transaction data and store in the same database, and create rules such that any map data request can only access the relevant information but not the rest of the transaction data.

In one implementation, each transaction results in a new row/set of data being created and stored. In other words, if the physical address of the merchant is not changed, there may be multiple sets of data with identical information except for the different time stamps. This can be useful if it is desirable to know the exact location of every individual transaction.

In one implementation, a new set of map data is still created and stored if the physical address of the merchant, thus the corresponding geographical coordinates, has changed from an earlier transaction.

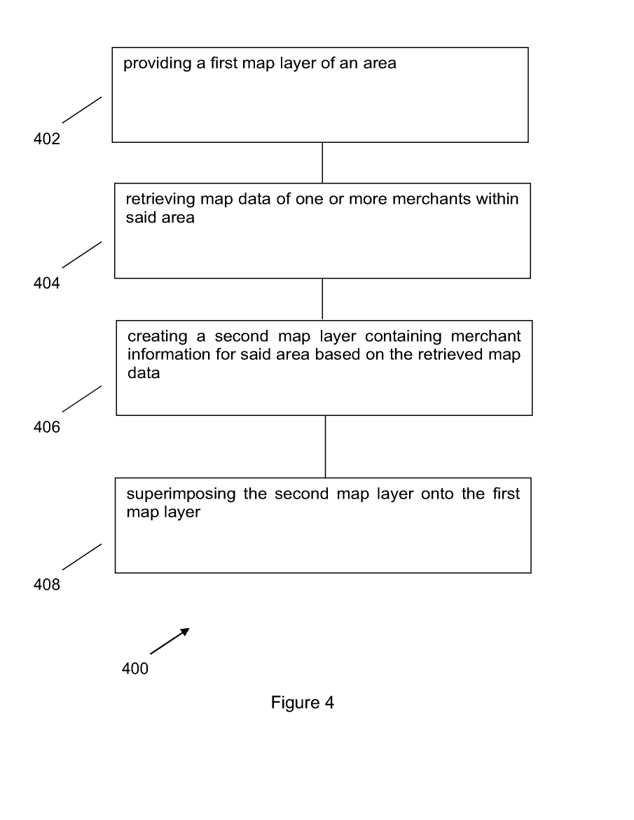

The map data as generated from the method illustrated in FIG. 2 can be used to create a merchant map of an area. FIG. 4 shows a flow chart 400 illustrating a method of creating a merchant map according to an example embodiment. At step 402, a first map layer of an area is provided. At step 404, map data of one or more merchants within said area, as generated using the method as described above with respect to FIG. 2, is retrieved. At step 406, a second map layer containing merchant information for said area is created based on the retrieved map data. At step 408, the second map layer is superimposed onto the first map layer.

In one application of the method as described above with reference to FIG. 4, the second map layer may be created in the form of a plurality of different sub-layers, each showing the merchant information of the same area as of a different point in time, and in step 408 of FIG. 4, the plurality of sub-layers may be provided sequentially over the same first map layer, like a motion picture or time-lapsed video. This can provide a visual demonstration of how a certain area changes, from a commercial perspective, over time.

Typically, the first map layer includes at least a street layout of the area, e.g. streets/roads and their respective names. The first map layer may also include other map features such as waterways, forests, parks, major landmarks, etc. The second map layer that is created in step 406 above typically includes one or more of the names, logos, and icons, etc. of the merchants at the respective geographical coordinates. Thus, the merchant map created by the method of the example embodiment can show such names/icons/logos of the merchants found at the exact locations on the first map layer.

As described above, the example embodiments provide a method to create a merchant map of a particular area based on the map data that is separately created and stored. In other words, the map data is available to any map service provider or organization. For example, while Google Maps may be used to obtain the map data, the stored map data can be accessed by other map companies, such as Bing Maps, Nokia Maps, etc. since the format of the stored map data is compatible with the APIs of these other map companies.

Moreover, the present method is not only able to create a merchant map from current map data, but also merchant maps of a particular area at different points in time using the time-stamps that are stored. For example, if a merchant map of an area A at a specified point in time (e.g. date D) is desired, the map data of any merchant within area A is retrieved in such a way that the sets of map data prior and closest to date D are used to create the second map layer. It will be appreciated that date D can be the current date or a date in the past. In other words, the last transaction before the specified point in time is considered the most relevant to the request. This can help to ensure that the correct data is used, since merchants may move their premises from time to time.

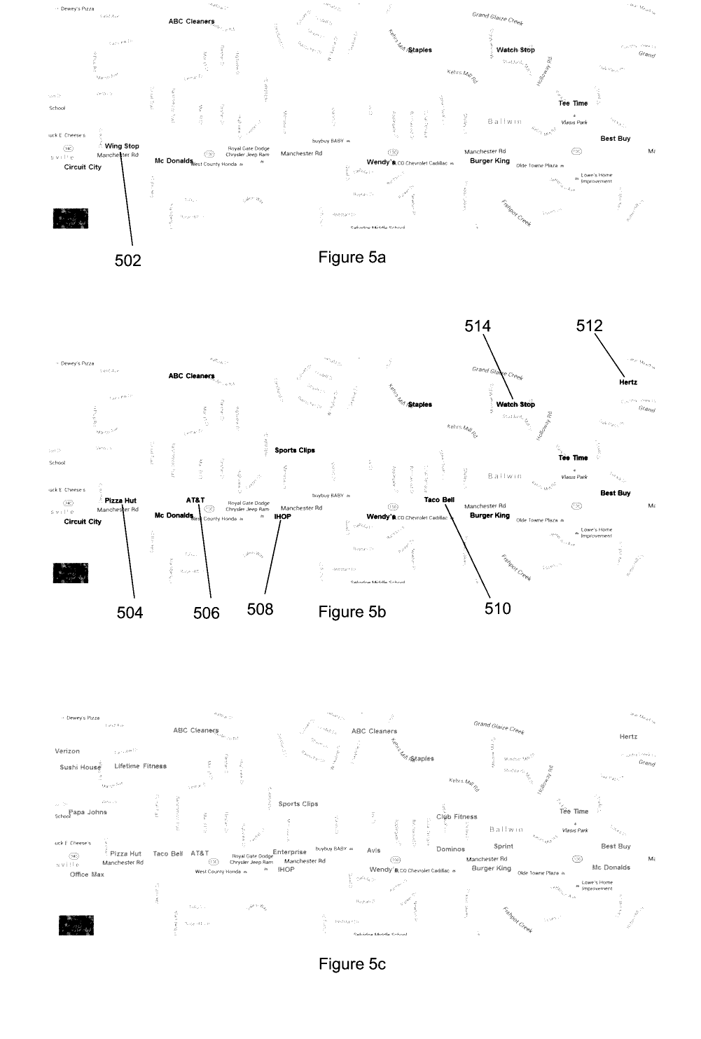

FIGS. 5a-5c shows example merchant maps of the same area that are created using the method of the example embodiments based on map data at different points in time. In FIG. 5a, which shows the map of the area in 2000, it can be seen that relatively few merchants/shops were present and the second merchant along Manchester Rd was “Wing Stop” 502. In FIG. 5b, which shows the map of the area in 2008, it can be seen that there are several changes from the earlier map. For example, the merchant “Wing Stop” 502 has been replaced by another merchant “Pizza Hut” 504, while new merchants such as “AT&T” 506, “IHOP” 508, “Taco Bell” 510 and “Hertz” 512 have appeared on the map. In FIG. 5c, which shows the map of the area in 2015, further changes are apparent. For example, more merchants have appeared along Manchester Rd including some replacements, while the merchant “Watch Stop” 514 in FIG. 5b is no longer present.

The map creation method of the example embodiments can provide a visually useful representation of the merchants in a given area. For example, it is possible to determine which area has a higher concentration of merchants and which area has a lower concentration of merchants. This may provide an indication of the levels of commercial development in different parts of a city, for example. Furthermore, the ability to generate maps based on historical data can show trends in the types of merchants/businesses in a particular area. These maps may find use in urban planning, social studies, etc. beyond the main application of providing up-to-date locations of various merchants or at any given point in time.

The example embodiments can be implemented on a computer system. For example, to generate map data, the computer system may have a merchant data interface where transaction data from the merchant is provided, e.g. over a communications network. A memory unit of the computer system is communicatively coupled with the merchant data interface and configured to receive transaction data from a merchant, the transaction data including merchant identification data and a time-stamp of the transaction. A processor of the computer system is communicatively coupled with the memory unit and configured to determine a physical address of the merchant from the merchant identification data, map the physical address of the merchant to corresponding geographical coordinates, and associate the geographical coordinates with the merchant's identity. A data storage unit of the computer system is communicatively coupled with the processor and configured to store the geographical coordinates, merchant's identity and time-stamp as elements of map data.

The merchant map can be created using the computer system described above, or a different computer system. Such computer system additionally may have an interface for receiving data of the first map layer from an external database or server, an interface for querying and obtaining the stored map data (as described above) for creating the second map layer.

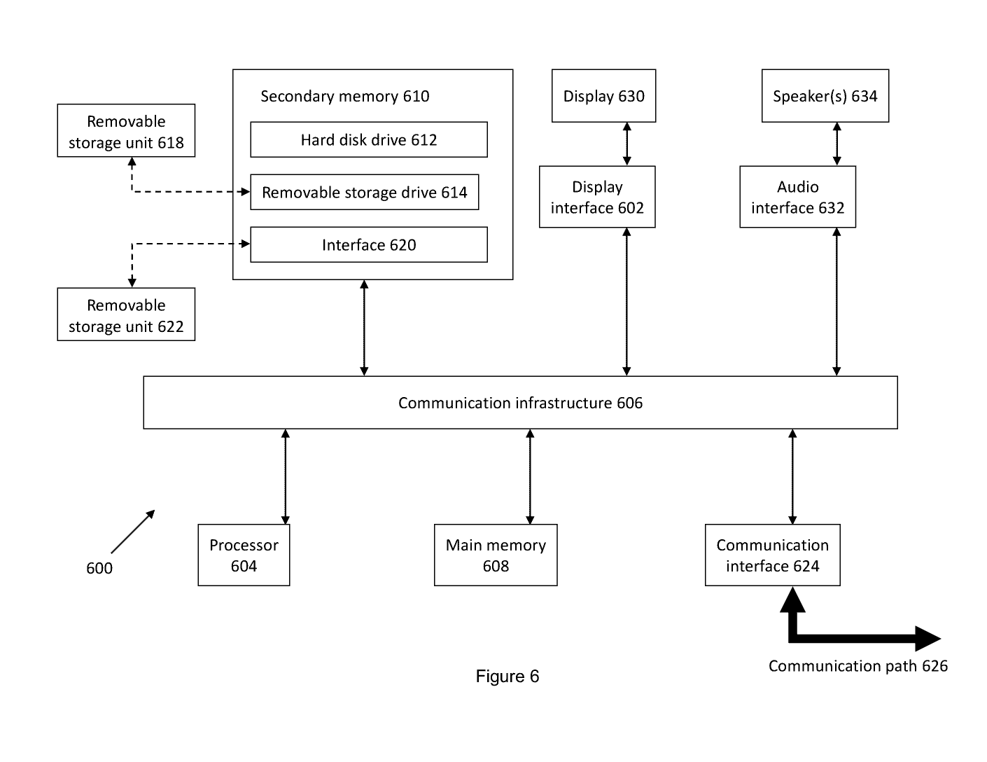

FIG. 6 depicts an exemplary computing device 600, hereinafter interchangeably referred to as a computer system 600, where one or more such computing devices 600 may be used in the generation of map data and/or the creation of merchant maps. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a hard disk drive 612 and/or a removable storage drive 614, which may include a floppy disk drive, a magnetic tape drive, an optical disk drive, or the like. The removable storage drive 614 reads from and/or writes to a removable storage unit 618 in a well-known manner. The removable storage unit 618 may include a floppy disk, magnetic tape, optical disk, or the like, which is read by and written to by removable storage drive 614. As will be appreciated by persons skilled in the relevant art(s), the removable storage unit 618 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 620. Examples of a removable storage unit 622 and interface 620 include a program cartridge and cartridge interface (such as that found in video game console devices), a removable memory chip (such as an EPROM or PROM) and associated socket, and other removable storage units 622 and interfaces 620 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the inventions, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port, an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage unit 618, removable storage unit 622, a hard disk installed in hard disk drive 612, or a carrier wave carrying software over communication path 626 (wireless link or cable) to communication interface 624. Computer readable storage media refers to any non-transitory tangible storage medium that provides recorded instructions and/or data to the computing device 600 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the hard disk drive 612, or the interface 620. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated that the elements illustrated in FIG. 6 function to provide means for performing the various functions and operations of the servers as described in the above embodiments.

In an implementation, a server may be generally described as a physical device comprising at least one processor and at least one memory including computer program code. The at least one memory and the computer program code are configured to, with the at least one processor, cause the physical device to perform the requisite operations.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of generating map data, the method comprising the steps of:
receiving transaction data from a merchant over a communications network, the transaction data including merchant identification data and a time-stamp of the transaction;
determining a physical address of the merchant from the merchant identification data;
mapping the physical address of the merchant to corresponding geographical coordinates using a geolocation database;
associating the geographical coordinates with the merchant's identity from the merchant identification data; and
storing, in a merchant map database, the geographical coordinates, merchant's identity and time-stamp as elements of map data.

2. The method as claimed in claim 1, wherein the step of determining a physical address of the merchant from the merchant identification data comprises extracting the physical address from a respective field in the merchant identification data.

3. The method as claimed in claim 1, wherein the step of determining a physical address of the merchant from the merchant identification data comprises identifying a merchant ID from the merchant identification data and querying a merchant address database containing a plurality of merchant IDs and associated addresses using the merchant ID.

4. The method as claimed in claim 1, wherein the step of storing the geographical coordinates, merchant's identity and time-stamp as elements of map data comprises storing a new set of map data if the geographical coordinates are changed.

5. The method as claimed in claim 1, wherein the step of mapping the physical address of the merchant to corresponding geographical coordinates comprises referencing a first map database containing a plurality of physical addresses and corresponding geographical coordinates using a merchant mapping engine.

6. The method as claimed in claim 1, wherein the step of storing the geographical coordinates, merchant's identity and time-stamp as elements of map data comprises making the map data accessible by an application programming interface (API).

7. A method of creating a merchant map, the method comprising:
providing a first map layer of an area;
retrieving map data of one or more merchants within said area, wherein the map data is generated using the method as claimed in any one of the preceding claims;
creating a second map layer containing merchant identity for said area based on the retrieved map data; and
superimposing the second map layer onto the first map layer.

8. The method as claimed in claim 7, wherein the step of providing a first map layer of an area comprises obtaining the first map layer corresponding to a specified point in time from a second map database, the first map layer including at least street layout of the area.

9. The method as claimed in claim 8, wherein the step of retrieving map data of one or more merchants comprises retrieving respective elements of map data having a time-stamp prior and closest to the specified point in time.

10. The method as claimed in any claim 7, wherein the step of creating a second map layer comprises creating a plurality of sub-layers, each sub-layer corresponding to a predetermined point in time.

11. The method as claimed in claim 10, wherein the step of superimposing the second map layer onto the first map layer comprises superimposing the plurality of sub-layers in a time-lapsed sequence.

12. The method as claimed in any one of claim 7, wherein the merchant identity comprises merchant names and/or merchant logos.

13. A system for generating map data, the system comprising:
a merchant data interface;
a memory unit communicatively coupled with the merchant data interface and configured to receive transaction data from a merchant over a communications network, the transaction data including merchant identification data and a time-stamp of the transaction;
a processor communicatively coupled with the memory unit and configured to determine a physical address of the merchant from the merchant identification data, map the physical address of the merchant to corresponding geographical coordinates using a geolocation database, and associate the geographical coordinates with the merchant's identity from the merchant identification data; and
a data storage unit communicatively coupled with the processor and configured to store the geographical coordinates, merchant's identity and time-stamp as elements of map data.

14. The system as claimed in claim 13, wherein the processor is configured to extract the physical address from a respective field in the merchant identification data.

15. The system as claimed in claim 13, wherein the processor is configured to identify a merchant ID from the merchant identification data and query a merchant address database containing a plurality of merchant IDs and associated addresses using the merchant ID to determine the physical address.

16. The system as claimed in claim 13, wherein the data storage unit is configured to store a new set of map data if the geographical coordinates are changed.

17. The system as claimed in any one of claim 13, wherein the processor is configured to reference a first map database containing a plurality of physical addresses and corresponding geographical coordinates.

18. The system as claimed in any one of claim 13, wherein the data storage unit is configured to make the map data accessible by an application programming interface (API).

19. The system of claim 13, wherein the processor is further configured to:
generate a first map layer of an area;
retrieve map data of one or more merchants within said area;
create a second map layer containing merchant identity for said area based on the retrieved map data; and
superimpose the second map layer onto the first map layer.

20. The system as claimed in claim 19, wherein the processor is configured to generate a first map layer by obtaining the first map layer corresponding to a specified point in time from a second map database, the first map layer including at least street layout of the area.

21. The system as claimed in claim 20, wherein the processor is further configured to retrieve respective elements of map data having a time-stamp prior and closest to the specified point in time.

22. The system as claimed in claim 19, wherein the processor is configured to create the second map layer by creating a plurality of sub-layers, each sub-layer corresponding to a predetermined point in time.

23. The system as claimed in claim 22, wherein the processor is further configured to superimpose the second map layer onto the first map layer by superimposing the plurality of sub-layers in a time-lapsed sequence.

24. The system as claimed in any one of claim 19, wherein the merchant identity comprises merchant names and/or merchant logos.
